(19) United States
(12) Patent Application Publication
(10) Pub. No.: US 2014/0022330 A1
(43) Pub. Date: Jan. 23, 2014

(54) Telepresence System and Method

(71) Applicant: Sanjay Bansal, Gurgaon (IN)

(72) Inventor: Sanjay Bansal, Gurgaon (IN)

(21) Appl. No.: 14/002,978

(22) PCT Filed: Mar. 2, 2012
(86) PCT No.: PCT/IN2012/000151

§ 371 Date: Oct. 8, 2013

(30) Foreign Application Priority Data
Mar. 3, 2011 (IN) 568/DEL/2011

(51) Int. Cl. H04N 7/15

(52) U.S. Cl. CPC H04N 7/152
USPC 348/14.07

(57) ABSTRACT

A telepresence participating room configured for audio visual communication with a plurality of other participating rooms is disclosed. The telepresence participating room comprises of a display system including a center stage and a participant stage, a plurality of codecs for powering the display system, a plurality of cameras for sharing audio visuals with the other participating rooms and a network switch for enabling communication with the other participating room, such that when an audio signal originates from a participating room for a predetermined time period, that participating room is considered an active participating room. The display system of the telepresence participating room is configured to display the active participating room in lifelike mode on the center stage as well as continuously display all the participating rooms on the participant stage.

### TECHNICAL FIELD

This invention relates to the field of telepresence systems and methods.

### BACKGROUND

As the global economy continues to expand, so does the need to be able to effectively communicate over distances. One area of communication that has seen steady growth and increased customer confidence is the use of telepresence. Telepresence has become an important and effective way of communication between individuals and groups over short and long distances. Telepresence creates an environment where a participant's meeting experience is similar to a real world meeting. The key requirements of a telepresence experience are appearance as real size life like images, good eye contact between the viewer and the speaker, and stereo spatial audio of the speaker.

However, while prior telepresence systems have provided improvements over audio/video conferencing systems, bulk of the requirements of telepresence are limited to a two location meeting only. The disparity between in-person conferences and the telepresence systems for the multiple locations meetings remains substantial. Conventionally, in a telepresence meeting involving multiple participants across multiple locations, each location was able to see the active speaker location in real-size life like mode, while other participant locations were not visible. As and when different participant locations became active by starting to speak, those locations were made visible to other participant locations. The switching from one active participant location to another is generally voice based in that a participant location was required to speak continuously for a few seconds before it was moved to the screens of the other participant locations. Such systems result in a huge disconnect between all participants as participants are only able to see the speaking location resulting in huge degradation of the meeting experience in comparison to a face to face meeting for everyone

Some other telepresence systems allow all participant locations to simultaneously see all other participant locations on their screens. This is achieved by splitting the available screen space equally amongst the other participant locations, and all participants from each location are displayed on the allocated screen space. However, by splitting the available screen space to accommodate all participant locations, the telepresence experience is completely compromised because participants do not appear real size and life like. There is no eye contact and also there is no stereo spatial audio of the speaker. On account of this users are required to scan the display screens, examining each user individually, to determine the person speaking. This is especially very difficult in a situation in which the screen is divided among several participant locations, and each location has multiple users within the camera's field of vision.

United States Patent Application Publication Number 2010/0073454 A1 to Lovhaugen et al., describes a system in which the active participant location is shown in a life like manner on the available screens while the other participant locations appear on the bottom of screen in a miniature form. Such an approach while attempting to address the limitations of the earlier systems also degrades the telepresence experience as it blocks the hand movement of the participants from the active location. As a result, while the participant locations at the bottom of the screen are too small to be effective, the active participant location is also compromised. The system disclosed by this document is further limited to only five locations in telepresence.

Existing systems therefore make participants choose whether to see only the speaking location in real size or to see all participants in a reduced size. As you see the participants in reduced size the stereo audio disappears, eye contact disappears and the complete telepresence experience disappears. This problem is further compounded when the number of participant location increases, particularly above 5 locations. There is therefore a need for an improved telepresence system and method that more closely replicates an in-person conference for multiple participant locations.

### BRIEF DESCRIPTION OF DRAWINGS

The following is a brief description of the preferred embodiments with reference to the accompanying drawings. It is to be understood that the features illustrated in and described with reference to the drawings are not to be construed as limiting of the scope of the invention. In the accompanying drawings:

FIG. 1 is a schematic illustration of a telepresence system in accordance with an embodiment of the invention.

FIG. 2 illustrates a telepresence system in accordance with an alternate embodiment of the invention.

FIG. 3 illustrates an example of a telepresence setting where 10 participating rooms are in conference with each other and one display is dedicated to show data input, such as presentations in accordance with an embodiment of the invention.

FIG. 4 illustrates an example of a telepresence system where 3 participating rooms are in conference with each other in accordance with an embodiment of the invention.

FIG. 5 illustrates an example of a telepresence system in accordance with an embodiment of the invention.

FIG. 6 illustrates an example of a telepresence system in accordance with an embodiment of the invention.

FIG. 7 illustrates an example of a telepresence system in accordance with an embodiment of the invention.

### SUMMARY

A telepresence participating room configured for audio visual communication with a plurality of other participating rooms is disclosed. The telepresence participating room comprises of a display system including a center stage and a participant stage, a plurality of codecs for powering the display system, a plurality of cameras for sharing audio-visuals with the other participating rooms and a network switch for enabling communication with the other participating rooms, such that when an audio signal originates from a participating room for a predetermined time period, that participating room is considered an active participating room. Herein the display system of the telepresence participating room is configured to display the active participating room in lifelike mode on the center stage as well as continuously display all the participating rooms on the participant stage.

A telepresence system comprising of at least three participating rooms is disclosed. Each participating room comprises of a display system, a plurality of codecs for powering the display system, a plurality of cameras for sharing audio-visuals with the other participating rooms, and a network switch for enabling communication with the other participating rooms such that when an audio signal originates from a participating room for a predetermined time period that participating room is considered an active participating room. Herein, the display system of the at least three participating rooms of the telepresence system comprises of a center stage and a participant stage. The telepresence system further comprises of a central control system in communication with the network switch of each participating room. The central control system is configured to connect the plurality of participating rooms in audio visual communication with each other. The central control system is further configured to identify a participating room with a display system having a center stage and a participant stage and to display the active participating room in lifelike mode on the center stage as well as continuously display all the participating rooms on the participant stage of that participating room.

A method of conducting an audio-visual telepresence conference between three or more participating rooms with at least three participating rooms is disclosed. The method of conducting audio visual telepresence conference between three or more participating rooms comprises of identifying a participating room with a display system having a center stage and a participant stage and to display the active participating room in lifelike mode on the center stage as well as continuously display all the participating rooms on the participant stage of that participating room.

### DETAILED DESCRIPTION

It will be understood by those skilled in the art that the foregoing objects and the following description of the nature of invention are exemplary and explanatory of the invention and are not intended to be restrictive thereof.

For the purpose of promoting an understanding of the principles of the invention, reference will now be made to various alternative embodiments and specific language will be used to describe the same. It will nevertheless be understood that no limitation of the scope of the invention is thereby intended, such alterations and further modifications in the illustrated method, and such further applications of the principles of the invention as illustrated therein being contemplated as would normally occur to one skilled in the art to which the invention relates.

It will be understood by those skilled in the art that the following description is exemplary and explanatory of the invention and are not intended to be restrictive thereof.

Many of the functional units described in this specification have been labeled as modules, in order to more particularly emphasize their implementation independence. For example, a module may be implemented as a hardware circuit comprising custom very large scale integration circuits or gate arrays, off-the-shelf semiconductors such as logic, chips, transistors, or the other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data maybe collected as a single data set, or may be distributed over different locations including over different member disks, and may exist, at least partially, merely as electronic signals on a system or network.

Reference throughout this specification to “one embodiment” “an embodiment” or similar language means that a particular feature, structure, or characteristic described in connection with the embodiment is included in at least one embodiment of the present invention. Thus, appearances of the phrase “in one embodiment”, “in an embodiment” and similar language throughout this specification may, but do not necessarily, all refer to the same embodiment.

The invention relates to a telepresence system and method for conducting a conference between different locations. In accordance with an embodiment, a location is a telepresence participating room.

According to an aspect, the invention relates to a telepresence system that allows for a highest quality audio video meeting experience which enables multiple participants across multiple telepresence participating rooms to be visible at all times to all participants at all the telepresence participating rooms' in continuous presence while simultaneously ensuring that a speaker participating room also appears in lifelike mode. The speaker participating room is considered to be the active participating room. The active participating room is displayed on a center stage while the other participating rooms are displayed on a participant stage. This overall experience will be called Tele-all-presence™experience. The telepresence system and method is configured for three or more participating rooms.

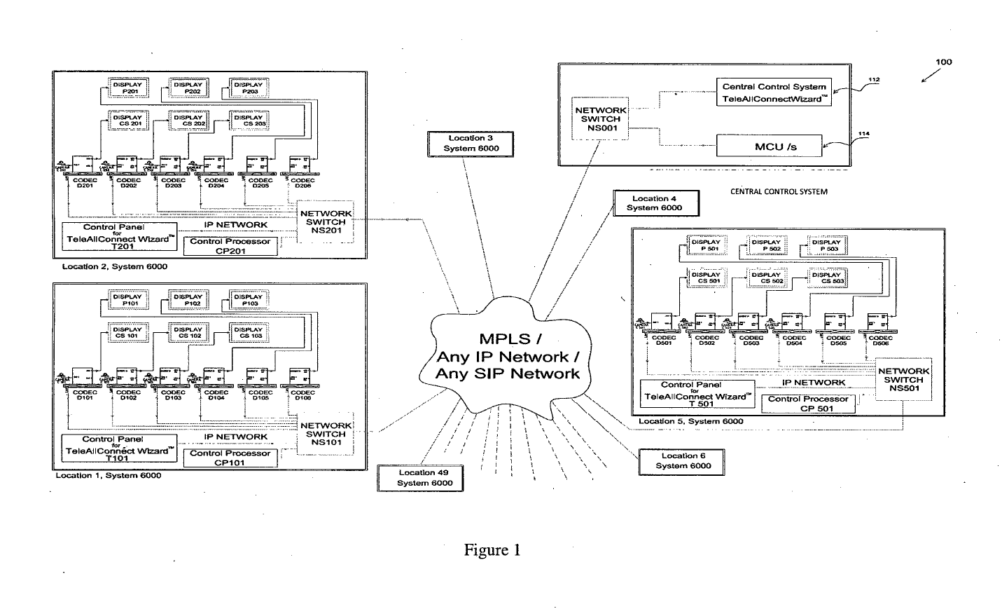

Referring initially to FIG. 1, a telepresence system environment (100) in accordance with an embodiment is illustrated. The telepresence system environment (100) comprises of a plurality of telepresence participating rooms, forty nine in the embodiment illustrated, that are connected by their network switches through the Multiprotocol Label Switching mechanism (MPLS) network/any kind of interne protocol network/any Session Initiation Protocol (SIP) network to a central control system (112). The Multiprotocol Label Switching mechanism (MPLS) network/any other IP network/any Session Initiation Protocol (SIP) network is configured to direct and carry data from one telepresence participating room to another telepresence participating room. The central control system (112) is configured with appropriate modules that enable the teachings of this disclosure. The MCU (114) is a device configured to perform functions like switching between different telepresence participating rooms in a teleconference call and serves as a bridge that interconnects calls from several locations. The system also provides several MCU to be used at the same time.

Each telepresence participating room is provided with a set of cameras, codecs and display system for the conference. The display system includes a center stage and a participant stage. The display system comprises of at least one display large enough to include the center stage and the participant stage or a plurality of displays to accommodate the center stage and the participant stage. The cameras, codecs and display system at each telepresence participating room are controlled by a control panel through a control processor and are configured with appropriate modules that enable the teachings of this disclosure. Still referring to FIG. 1, each telepresence participating room in the example illustrated is provided with a set of six displays, six codecs and four cameras. For example, telepresence participating room (Location 1) includes six displays of which three are configured as participant stage displays (P101, P102 and P103) and three are configured as the center stage displays (CS 101, CS 102 and CS 103). Each display is powered by a corresponding codec (D 101 to D 106). The cameras (C 101 to C 104) are appropriately positioned in the room to capture the entire conference room as per the requirement. Telepresence participating room (Location 1) further includes a control panel (T101), a control processor (CP 101) and a network switch (NS101). The network switches (NS101, NS001) include components required for setting up the telepresence call such as a router. Similar configurations of display system, codecs, cameras, control panel, control processor and network switch is provided at the other participating rooms as well. The displays at each telepresence participating room are preferably large-scaled flat screens (between 58″ to 65″ preferably) placed side by side in two rows, with the cameras appropriately placed in between. The number of cameras at each telepresence participating room is three to five, preferably four. The number of displays for the center stage is preferably three.

A Codec (coder/decoder) is a hardware or software that performs digital compression of audio and video streams. The control panel is powered by modules that provide a user interface facilitating initiation of calls and performance of other Input/Output functions related to the conference. The control panel also assists users to select the participating rooms for the conference and allocate available bandwidth through the central control system. The control processor of each participating room connects with the central control system (112) that also controls the Multipoint Control Unit or MCU (114). MCU (114) is a device/devices configured to serve as a bridge/bridges among different participating rooms in a teleconference call.

In accordance with an aspect of the invention, a telepresence participating room initiates a conference through its control panel and connects with the central control system (112). The control panel of the initiating telepresence participating room transmits details of available infrastructure and also provides the central control system details of the conference and the participating rooms. The central control system (112) in turn instructs the MCU/s about the participating rooms and how the various codecs at all the participating rooms are to be connected using available resources. The central control system (112) not only transmits instructions to the MCU/s about various participating rooms and how to set up connections between them, but also keeps track of the status of the conference, identifies addresses of codecs at the participating rooms, allocates bandwidth for the conference, rearranges communication links when a participating room joins or leaves during the conference, etc. The central control system (112) sends a stream of Internet protocol (IP) packets to the control processors of the participating rooms via the network switch (NS 001). The IP packets may include details indicating the nature of the call, addresses of the respective codecs etc.

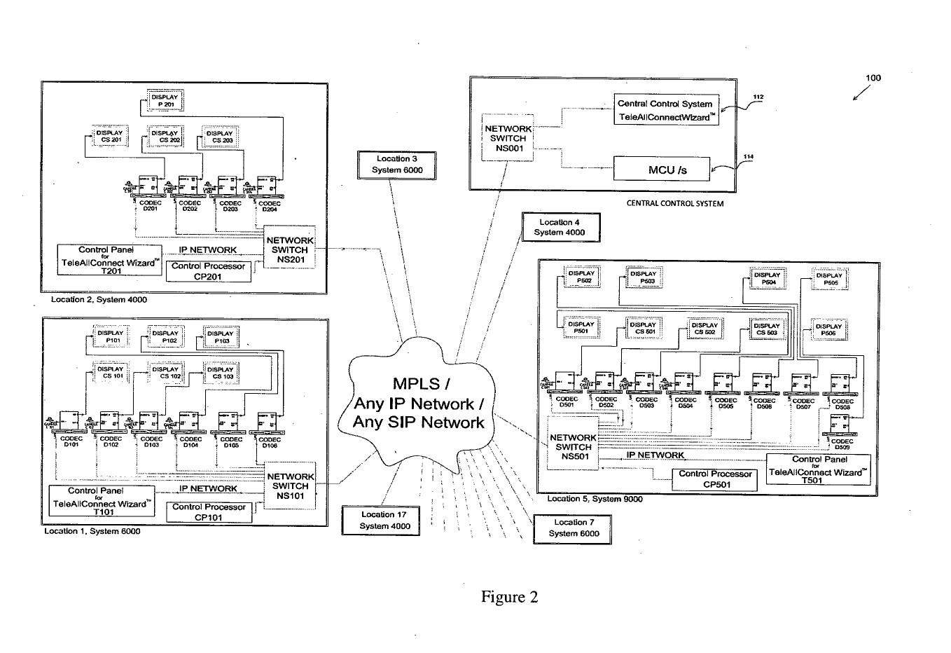

In accordance with an embodiment, each participating room may have different configuration of the Tele-all-presence™ system. FIG. 2 illustrates an example of a Tele-all-presence™ setting where seventeen Tele-all-presence™ systems at seventeen participating rooms are in conference with each other in accordance with an embodiment of the invention. A conference between various Tele-all-presence™ systems (100) is arranged by setting up location-to-location connections between MCU (114) and codecs of each participating room.

In the embodiment illustrated in FIG. 1, each participating room is shown to have 6 displays. It is not however necessary for each participating room to have the same number of displays. Referring to FIG. 2, a telepresence call between seventeen participating rooms is illustrated with some participating rooms having four displays (system 4000) while some participating rooms are provided with six displays (system 6000) and some other provided with 9 displays (system 9000). In the embodiment illustrated, the participating room 2 (location 2) is shown to have four displays each while participating room 1 (location 1) is shown to have six displays and participating room 5 (location 5) is shown to have 9 displays. In such set ups the central control system by giving instructions to the MCU/s (112) allocates codecs between participating rooms such that each participating room is able to see the active participating room on their center stage display along with seeing all the participating rooms on the participant stage display.

The number of displays required depends on the number of total participating rooms sought to be connected and the relative quality of experience sought. The displays with the center stage are preferably placed below the participant stage displays. At a minimum two large displays are required, one serving as the participant stage display and the other as the center stage display. In accordance with a preferred embodiment, four displays are required at each location with 3 displays serving as centre stage and one display serving as participant stage. In other embodiments, the number of centre stage displays remains as three but the number of participant displays increase to 3 or 6. The center stage is always located centrally on the bottom row of display screens.

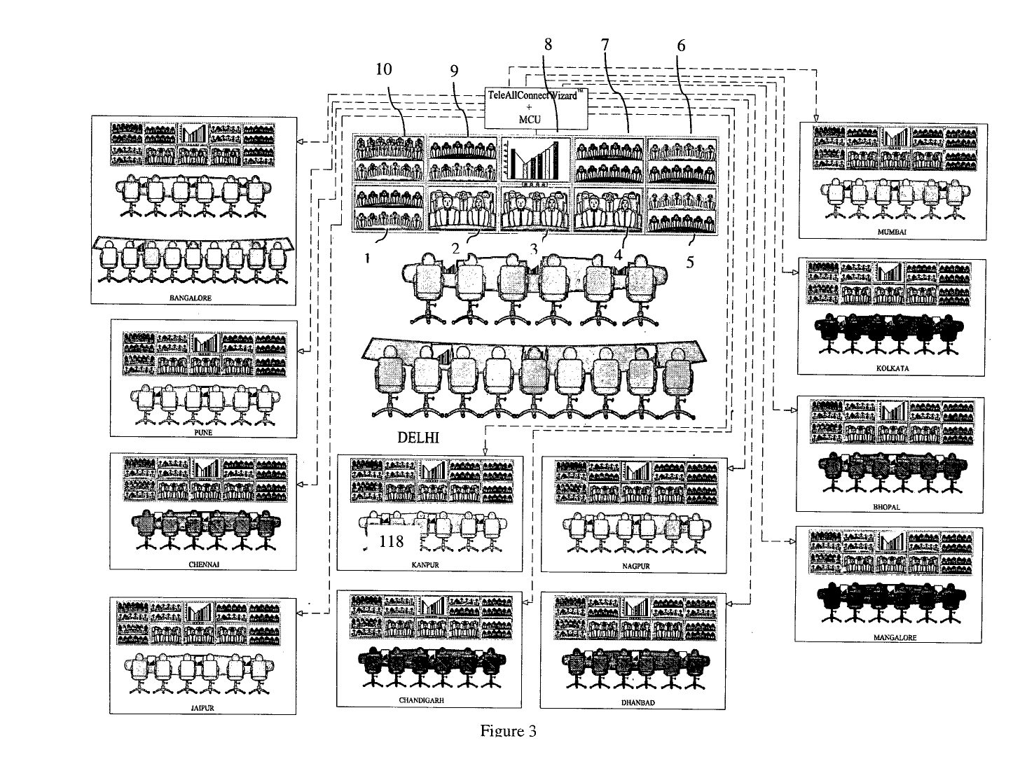

Referring next to FIG. 3, thirteen participating rooms are shown in conference with each participating room having ten displays. The displays are arranged in two rows of five each with the central three displays (2, 3, 4) in the bottom row serving as the center stage displays on which the active participating room is displayed. In the embodiment illustrated, one display (8) is configured for presentation data and other shared applications. The remaining six displays (1, 5, 6, 7, 9, and 10) serving as the participant stage displays are configured to simultaneously display the other participating rooms. Each participating room can simultaneously see all participating rooms in the participant stage displays (1, 5, 6, 7, 9, and 10) as well as simultaneously see the active participating room on the center stage (2, 3, and 4). In effect, all participating rooms can see all participating rooms at all times and the active participating room or the speaker location appears on the center stage displays (2, 3, and 4) in a real size and life like mode.

In accordance with an embodiment, the telepresence system is configured to display the active participating room on the center stage (2, 3, and 4) within few seconds of a switch in speaker participating room. If a participant from Bangalore starts speaking, then the entire Bangalore participating room will appear in life like mode on the center stage of all other participating rooms.

In accordance with an embodiment, as more participating rooms are added, the telepresence system (100) is configured to divide the participant stage displays further to accommodate the newly added participating rooms. In accordance with an aspect, a display may be divided to show a maximum of sixteen participating rooms.

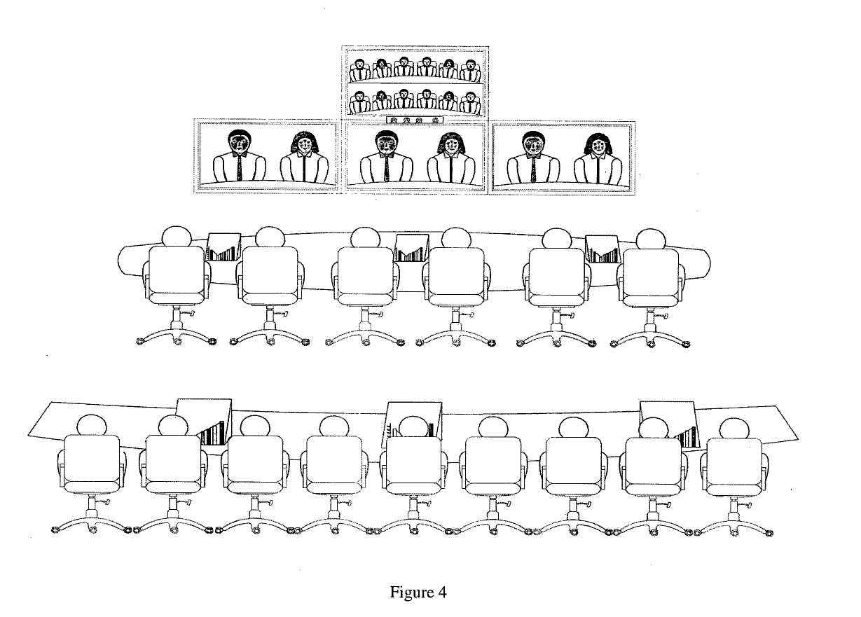

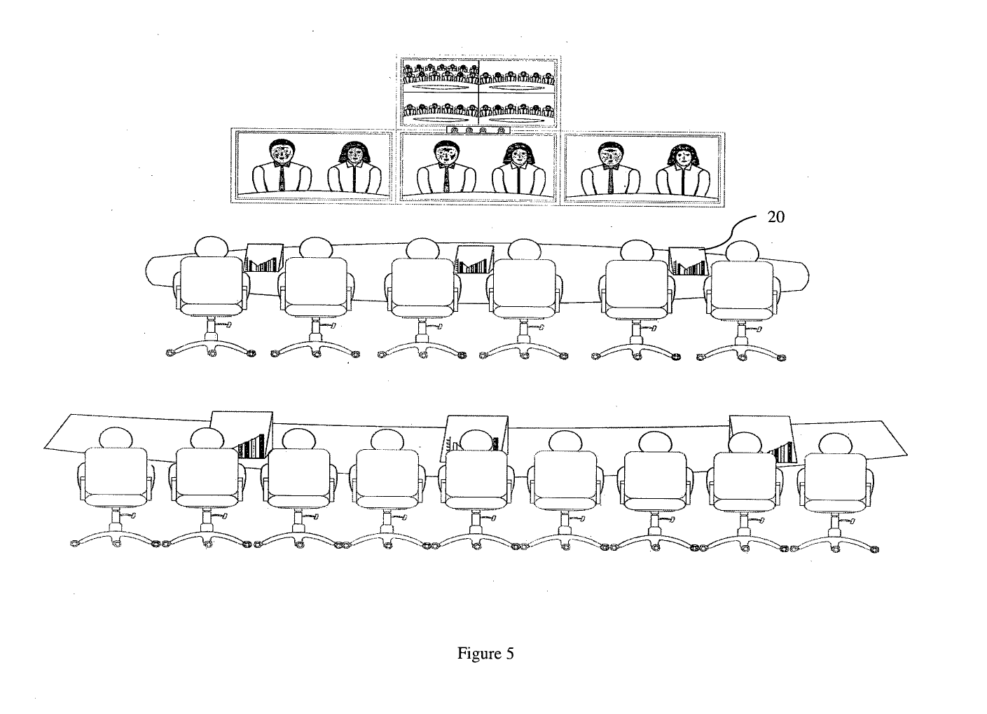

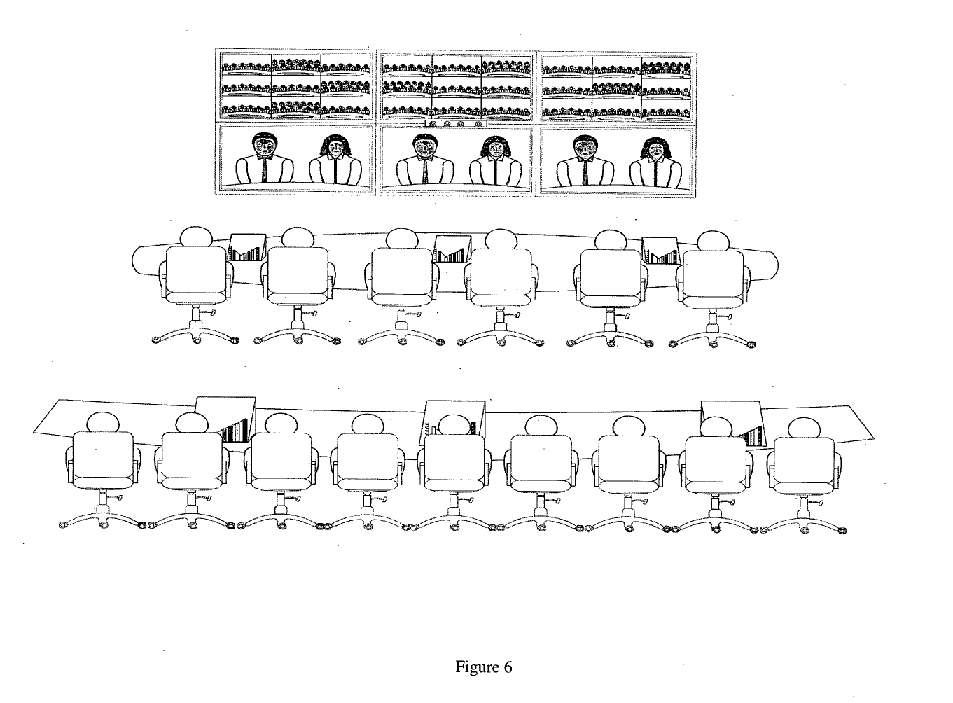

With reference to FIGS. 4 to 6 various embodiments of the participant stage display and the center stage display are illustrated, with the number of displays at each participating room varying. As illustrated in FIG. 4, a total of 3 participating rooms are in conference with a four display set up, while FIGS. 5 and 6 illustrate a total of 5 and 24 participating rooms in conference. In the four displays set up of FIGS. 4 and 5, three displays are center stage displays with a single participant stage display. In FIG. 6 three displays are center stage displays and three displays are participant stage displays.

In accordance with an embodiment, the tables at one or more participating rooms are provided with motorized pop up displays (20) to display presentations or other shared materials as illustrated in FIG. 5.

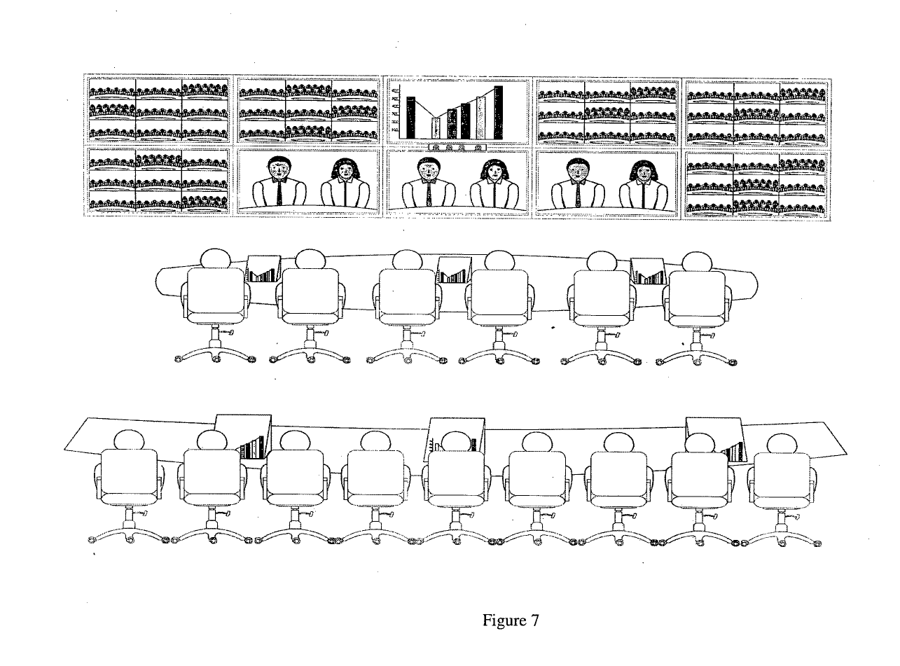

In accordance with an embodiment, different participating rooms may have different number of participants. For example, FIG. 7 shows a total of 55 participating rooms in conference with each participating room having different number of participants.

While specific language has been used to describe the invention, any limitations arising on account of the same are not intended. As would be apparent to a person in the art, various working modifications may be made to the system in order to implement the inventive concept as taught herein.

### SPECIFIC EMBODIMENTS ARE DESCRIBED BELOW

A telepresence participating room configured for audio visual communication with a plurality of other participating rooms is disclosed. The telepresence participating room comprises of a display system including a center stage and a participant stage, a plurality of codecs for powering the display system, a plurality of cameras for sharing audio-visuals with the other participating rooms. The telepresence participating room further comprises of a network switch for enabling communication with the other participating rooms, such that when an audio signal originates from a participating room for a predetermined time period, that participating room is considered an active participating room. Herein the display system of the telepresence participating room is configured to display the active participating room in lifelike mode on the center stage as well as continuously display all the participating rooms on the participant stage.

Such telepresence participating room(s) wherein the center stage is positioned below the participant stage.

Such telepresence participating room(s) wherein the display system comprises of a plurality of displays, with at least one display dedicated as a center stage display.

Such telepresence participating room(s) wherein at least one display is dedicated as a participant stage display.

Such telepresence participating room(s) wherein the center stage display is positioned between two or more participant stage displays.

Such telepresence participating room(s) further comprises of a control panel in communication with the network switch, configured for call initiation, selection of participating rooms and allocation of available bandwidth.

### FURTHER SPECIFIC EMBODIMENTS ARE DESCRIBED BELOW

A telepresence system comprising at least three participating rooms is disclosed. Each participating room comprises of a display system, a plurality of codecs for powering the display system, a plurality of cameras for sharing audio-visuals with the other participating rooms, and a network switch for enabling communication with the other participating rooms such that when an audio signal originates from a participating room for a predetermined time period that participating room is considered an active participating room. Herein, the display system of the at least three participating rooms of the telepresence system comprises of a center stage and a participant stage. The telepresence system further comprises of a central control system in communication with the network switch of each participating room. The central control system is configured to connect the plurality of participating rooms in audio visual communication with each other. The central control system is further configured to identify a participating room with a display system having a center stage and a participant stage and to display the active participating room in lifelike mode on the center stage as well as continuously display all the participating rooms on the participant stage of that participating room.

Such telepresence system(s) wherein the center stage is positioned below the participant stage.

Such telepresence system(s) wherein the display system of the participating rooms comprising of a center stage and a participant stage comprises of a plurality of displays, with at least one display dedicated as a center stage display.

Such telepresence system(s) wherein at least one display is dedicated as a participant stage display.

Such telepresence system(s) wherein the center stage display is positioned between two or more participant stage displays.

### FURTHER SPECIFIC EMBODIMENTS ARE DESCRIBED BELOW

A method of conducting an audio-visual telepresence conference between three or more participating rooms with at least three participating rooms is disclosed. Each participating room comprises of a display system including a center stage and a participant stage, a plurality of codecs for powering the display system, a plurality of cameras for sharing audio-visuals with the other participating rooms and a network switch for enabling communication with the other participating rooms such that when an audio signal originates from a participating room for a predetermined time period, that participating room is considered an active participating room. The method further comprises of identifying a participating room with a display system having a center stage and a participant stage and to display the active participating room in lifelike mode on the center stage as well as continuously display all the participating rooms on the participant stage of that participating room.

Such method(s) wherein the center stage is positioned below the participant stage.

Such method(s) wherein the display system comprises of a plurality of displays, with at least one display dedicated as a center stage display and at least two displays dedicated as participant stage displays, the method comprising positioning the center stage display between the participant stage displays.

We claim:

1. A telepresence participating room configured for audio visual communication with a plurality of other participating rooms, the telepresence participating room comprising:
a display system including a center stage and a participant stage;
a plurality of codecs for powering the display system;
a plurality of cameras for sharing audio-visuals with the other participating rooms; and
a network switch for enabling communication with the other participating rooms; such that when an audio signal originates from a participating room for a predetermined time period, that participating room is considered an active participating room;
wherein the display system is configured to display the active participating room in lifelike mode on the center stage as well as continuously display all the participating rooms on the participant stage.

2. A telepresence participating room as claimed in claim 1 wherein the center stage is positioned below the participant stage.

3. A telepresence participating room as claimed in claim 1 wherein the display system comprises of a plurality of displays, with at least one display dedicated as a center stage display.

4. A telepresence participating room as claimed in claim 3 wherein at least one display is dedicated as a participant stage display.

5. A telepresence participating room as claimed in claim 4 wherein the center stage display is positioned between two or more participant stage displays.

6. A telepresence participating room as claimed in claim 1 further comprising a control panel in communication with the network switch, configured for call initiation, selection of participating rooms and allocation of available bandwidth.

7. A telepresence system comprising:
at least three participating rooms each comprising a display system, a plurality of codecs for powering the display system, a plurality of cameras for sharing audio-visuals with the other participating rooms, and a network switch for enabling communication with the other participating rooms; such that when an audio signal originates from a participating room for a predetermined time period that participating room is considered an active participating room; wherein the display system of the at least three participating rooms comprises of a center stage and a participant stage;
a central control system in communication with the network switch of each participating room and configured to connect the plurality of participating rooms in audio visual communication with each other, the control system further configured to identify a participating room with a display system having a center stage and a participant stage and to display the active participating room in lifelike mode on the center stage as well as continuously display all the participating rooms on the participant stage of that participating room.

8. A telepresence system as claimed in claim 7 wherein the center stage is positioned below the participant stage.

9. A telepresence system as claimed in claim 7 wherein the display system of the participating rooms comprising of a center stage and a participant stage comprises of a plurality of displays, with at least one display dedicated as a center stage display.

10. A telepresence system as claimed in claim 9 wherein at least one display is dedicated as a participant stage display.

11. A telepresence system as claimed in claim 10 wherein the center stage display is positioned between two or more participant stage displays.

12. A method of conducting an audio-visual telepresence conference between three or more participating rooms with, at least three participating rooms comprising:
a display system including a center stage and a participant stage;
a plurality of codecs for powering the display system;
a plurality of cameras for sharing audio-visuals with the other participating rooms; and
a network switch for enabling communication with the other participating rooms; such that when an audio signal originates from a participating room for a predetermined time period, that participating room is considered an active participating room; the method comprising:
identify a participating room with a display system having a center stage and a participant stage and to display the active participating room in lifelike mode on the center stage as well as continuously displaying all the participating rooms on the participant stage of that participating room.

13. A method as claimed in claim 12 wherein the center stage is positioned below the participant stage.

14. A method as claimed in claim 12 wherein the display system comprises of a plurality of displays, with at least one display dedicated as a center stage display and at least two displays dedicated as participant stage displays, the method comprising positioning the center stage display between the participant stage displays.
